(19) United States
(12) Patent Application Publication
(10) Pub. No.: US 2011/0157365 A1
(43) Pub. Date: Jun. 30, 2011

(54) HEAD-MOUNTED DISPLAY

(75) Inventor: Tomohiro SATO, Nagoya-shi (JP)

(73) Assignee: BROTHER KOGYO KABUSHIKI KAISHA, NAGOYA-SHI (JP)

(21) Appl. No.: 12/974,807

(22) Filed: Dec. 21, 2010

(30) Foreign Application Priority Data
Dec. 28, 2009 (JP) 2009-297133

(51) Int. Cl. H04N 7/18; G09G 5/00

(52) U.S. Cl. 348/158; 345/634; 348/E07.085

(57) ABSTRACT

A head-mounted display includes an image capture device that captures an image; a first setting device that sets a starting time for the capturing of the image; a start command device that causes the image capture device to start capturing the image at the starting time; a first acquiring device that acquires an audio text in which sound that is emitted by a captured object has been converted into text; a storage control device that stores in a storage device the image that has been captured during an interval from the time that the capturing of the image is started until the audio text is acquired; a first creating device that creates a display image in which the captured image and the audio text are synchronized by superimposing the audio text on the captured image; and a display control device that outputs the display image.

### CROSS-REFERENCE TO RELATED APPLICATION

This application claims priority from JP2009-297133, filed on Dec. 28, 2009, the content of which is hereby incorporated by reference.

### BACKGROUND

The present disclosure relates to a head-mounted display. More specifically, the present disclosure relates to a head-mounted display that adds text information to an image and displays both the text information and the image.

A head-mounted display is known that adds text information for audio to one of a captured image and a live image and displays both the text information and the image. By visually recognizing the text information at the same time as the one of the captured image and the live image, a user of the head-mounted display can recognize that the one of the captured image and the live image and the text information are associated with one another.

A head-mounted display is known that is used for dubbing foreign-language dialogue in foreign films into Japanese, and it displays dialogue information that corresponds to a captured image. The user of the head-mounted display is able to simultaneously recognize the captured image that is displayed on a screen such as a large display, a projection screen, or the like and the dialogue information that is displayed on the head-mounted display. This makes it possible for the user to perform the work of dubbing the dialogue without having to alternately look at a script and the image.

### SUMMARY

However, with the head-mounted display that is described above, in a case where the text information such as the dialogue information or the like has not been prepared in advance, it is necessary for the text information to be created from audio for the captured image, using voice recognition or the like, and for the created text information to be associated with the captured image. In that ease, time is required in order to create the text information, which creates a problem in that the creation of the text information cannot keep pace with the progress of the captured image, so the captured image and the text information cannot be synchronized.

The present disclosure provides a head-mounted display that can easily synchronize and display the captured image and the text information.

To solve the problem described above, in a first aspect of this disclosure, a head-mounted display includes an image capture device that captures an image; a first setting device that sets a starting time for the capturing of the image by the image capture device; a start command device that causes the image capture device to start capturing the image at the starting time that has been set by the first setting device; a first acquiring device that, after the starting time that has been set by the first setting device, acquires an audio text in which sound that is emitted by an object captured by the image capture device has been converted into text; a storage control device that stores in a storage device the image that has been captured during an interval from the time that the capturing of the image is started by the start command device until the audio text is acquired by the first acquiring device; a first creating device that, after the audio text has been acquired by the first acquiring device, creates a display image in which the captured image and the audio text are synchronized by superimposing the audio text on the captured image such that the starting time of the captured image that is stored in the storage device and the starting time of a display of the audio text are matched to one another; and a display control device that outputs the display image that has been created by the first creating device.

To solve the problem described above, in a second aspect of this disclosure, a head-mounted display includes an image capture device that captures an image; and a processor that is configured to execute instructions that are grouped into functional units, the instructions including a first setting unit that sets a starting time for the capturing of the image by the image capture device, a start command unit that causes the image capture device to start capturing the image at the starting time that has been set by the first setting unit, a first acquiring unit that, after the starting time that has been set by the first setting unit, acquires an audio text in which sound that is emitted by an object captured by the image capture device has been converted into text, a storage control unit that stores in a storage device the image that has been captured during an interval from the time that the capturing of the image is started by the start command unit until the audio text is acquired by the first acquiring unit, a first creating unit that, after the audio text has been acquired by the first acquiring unit, creates a display image in which the captured image and the audio text are synchronized by superimposing the audio text on the captured image such that the starting time of the captured image that is stored in the storage device and the starting time of a display of the audio text are matched to one another, and a display control unit that outputs the display image that has been created by the first creating unit.

To solve the problem described above, in a third aspect of this disclosure, a computer program product stored on a non-transitory computer-readable medium, comprising instructions for causing a processor of a head-mounted display to execute the steps of: a first setting step that sets a starting time for capturing of an image; a start command step that causes the capturing of the image to start at the starting time that has been set in the first setting step; a first acquiring step that, after the starting time that has been set in the first setting step, acquires an audio text in which sound that is emitted by a captured object has been converted into text; a storage control step that stores the image that has been captured during an interval from the time that the capturing of the image is started in the start command step until the audio text is acquired in the first acquiring step; a first creating step that, after the audio text has been acquired in the first acquiring step, creates a display image in which the captured image and the audio text are synchronized by superimposing the audio text on the captured image such that the starting time of the stored captured image and the starting time of a display of the audio text are matched to one another; and a display control step that outputs the display image that has been created in the first creating step.

### BRIEF DESCRIPTION OF THE DRAWINGS

Exemplary embodiments will be described below in detail with reference to the accompanying drawings in which:

FIG. 1 is a schematic diagram that shows a general view of a system configuration that includes an HMD;

FIG. 2 is a schematic figure that shows a general view of the HMD;

FIG. 3 is a block diagram that shows an electrical configuration of the HMD;

FIG. 4 is a flowchart that shows recognition processing;

FIG. 5 is a flowchart that shows image capture processing;

FIG. 6 is a flowchart that shows display processing;

FIG. 7 is a figure that shows a displayed image; and

FIG. 8 is a flowchart that shows audio text acquisition processing.

### DETAILED DESCRIPTION

Hereinafter, a head-mounted display (hereinafter called the HMD) 200 according to an embodiment of the present disclosure will be explained with reference to the drawings. The drawings are used to explain technological features that can be used in the present disclosure. Device configurations, flowcharts of various types of processing, and the like that are shown in the drawings are merely explanatory examples and do not limit the present disclosure.

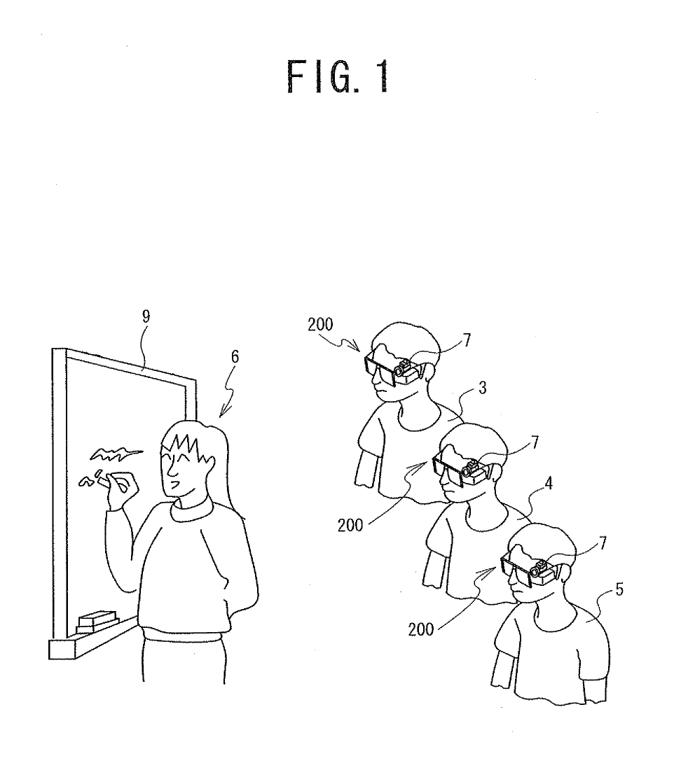

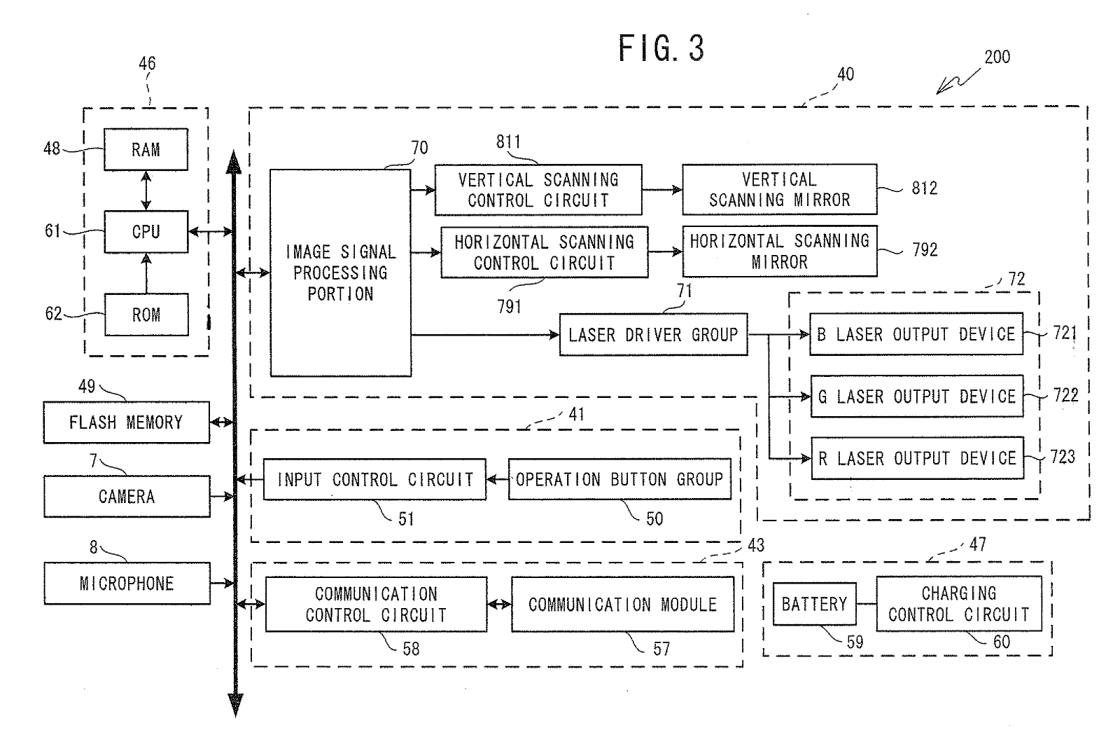

An overview of the HMD 200 and a system configuration that includes the HMD 200 will be explained with reference to FIG. 1. Each one of users 3 to 5 is wearing the HMD 200. The users 3 to 5 are watching and listening to an explanation by an explainer 6, and the field of view of each of the users 3 to 5 is directed toward the explainer 6. Each of the HMDs 200 is provided with a camera 7 that captures an image in the direction of the field of view of the one of the users 3 to 5 who is wearing the HMD 200. Therefore, the camera 7 of each of the HMDs 200 that the users 3 to 5 are wearing is in a state of being able to capture an image of the explainer 6. Each of the HMDs 200 is provided with a microphone 8 (refer to FIG. 3). The microphone 8 collects the sound of the explainer 6's speech (hereinafter called the speech sound).

In the present embodiment, the speech sound of the explainer 6 is collected by the microphone 8 and subjected to voice recognition processing. The voice recognition processing creates text information (hereinafter called the audio text) that shows the content of the speech (hereinafter called the speech content). An image of the explainer 6 is also captured by the camera 7 of the HMD 200. In the HMD 200, the audio text that has been created as a result of the voice recognition processing is superimposed on the image that has been captured by the camera 7 (hereinafter called the captured image). In that process, the starting time of the captured image and the starting time of the audio text display are matched. This creates an image (hereinafter called the display image) in which the captured image and the audio text are synchronized. By viewing the display image, the users 3 to 5 of the HMDs 200 are able to recognize that the captured image of the explainer 6 and the audio text are associated with one another. In a case where the explainer 6 is delivering an explanation while pointing to a whiteboard 9, for example, creating the display image in which the displays of the captured image and the audio text are synchronized in this manner means that, in the display image, the display of the audio text that shows the content of the explanation is synchronized to the timing at which the explainer 6 points to the whiteboard 9. The users 3 to 5 are therefore able to adequately understand the explainer 6's explanation.

Note that in the explanation above, the HMD 200 uses the voice recognition processing to create the audio text that shows the speech content, but the present disclosure is not limited to this method. For example, in a case where the users 3 to 5 cannot understand the language that is spoken by the explainer 6, the audio text may be created by taking the text information that is produced as a result of the voice recognition processing and translating it for each of the users 3 to 5 into a language that that one of the users 3 to 5 can understand. Because each of the users 3 to 5 visually recognizes the display image that is created based on the created audio text, the users 3 to 5 are able to understand the speech content even in a case where they cannot understand the language that the explainer 6 is speaking.

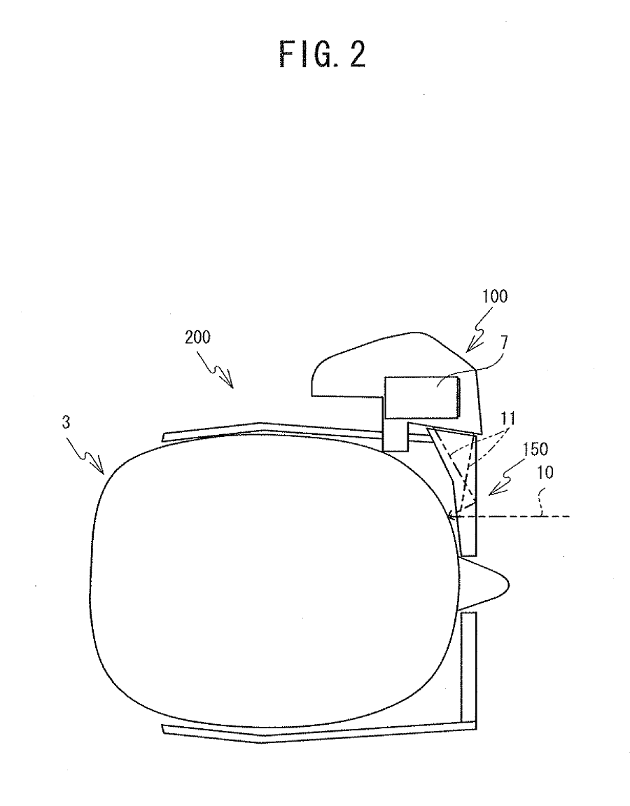

The configuration of the HMD 200 will be explained with reference to FIG. 2. The HMD 200 is what is called a retinal scanning display. A retinal scanning display scans, in two dimensions, a beam of light that corresponds to an image signal, directs the scanned light into the user's eye, and projects an image on the retina. Note that the HMD 200 is not limited to being a retinal scanning display. For example, the HMD 200 may also be provided a different image display device, such as a liquid crystal display, an organic electroluminescence (EL) display, or the like.

As shown in FIG. 2, the HMD 200 scans a laser beam (hereinafter called the image beam 11) that is modulated in accordance with the image signal and outputs the image beam 11 onto the retina of an eye of at least one of the users 3 to 5. Because the image is projected directly onto the retina of the user of the HMD 200, the user is able to visually recognize the image. The HMD 200 is provided with at least an output device 100, a prism 150, and the camera 7.

The output device 100 outputs the image beam 11 toward the prism 150 in accordance with the image signal, in which the image that the user visual recognizes has been converted into a signal. The prism 150 is disposed in a fixed position in relation to the output device 100. The prism 150 reflects the image beam 11 that has been output from the output device 100 toward the eye of the user. The prism 150 is provided with a beam splitter portion that is not shown in the drawings. The prism 150 allows an external light beam 10 from outside to pass through and directs it into the eye of the user. The configuration that has been described allows the prism 150 to direct the image beam 11 that enters the prism 150 from the output device 100 into the eye of the user and also allows the prism 150 to direct the external light beam 10 from outside into the eye of the user. This makes it possible for the user to visually recognize both the live field of vision and the image that is based on the image beam 11 that is output from the output device 100. The camera 7 captures an image of what is visible in the direction of the user's field of view.

The electrical configuration of the HMD 200 will be explained with reference to FIG. 3. As shown in FIG. 3, the HMD 200 is provided with a display portion 40, an input portion 41, a communication portion 43, a flash memory 49, a control portion 46, the camera 7, the microphone 8, and a power supply portion 47.

The display portion 40 displays the image to the user. The display portion 40 is provided with an image signal processing portion 70, a laser group 72, and a laser driver group 71. The image signal processing portion 70 is electrically connected to the control portion 46. The image signal processing portion 70 receives the image signal from the control portion 46 and converts the image signal into various signals that are necessary in order to project the image directly onto the retina of the user. The laser group 72 includes a blue output laser (hereinafter called the B laser output device) 721, a green output laser (hereinafter called the G laser output device) 722, and a red output laser (hereinafter called the R laser output device) 723. The laser group 72 outputs blue, green, and red laser beams. The laser driver group 71 performs control in order to allow the laser beams to be output from the laser group 72. The image signal processing portion 70 is electrically connected to the laser driver group 71. The laser driver group 71 is electrically connected to each of the B laser output device 721, the G laser output device 722, and the R laser output device 723. The image signal processing portion 70 is capable of outputting the desired laser beams at the desired timings.

The display portion 40 is also provided with a vertical scanning mirror 812, a vertical scanning control circuit 811, a horizontal scanning mirror 792, and a horizontal scanning control circuit 791. The vertical scanning mirror 812 performs scanning by reflecting in the vertical direction the laser beams that are output by the laser group 72. The vertical scanning control circuit 811 performs drive control of the vertical scanning mirror 812. The horizontal scanning mirror 792 performs scanning by reflecting in the horizontal direction the laser beams that are output by the laser group 72. The horizontal scanning control circuit 791 performs drive control of the horizontal scanning mirror 792. The image signal processing portion 70 is electrically connected to each of the vertical scanning control circuit 811 and the horizontal scanning control circuit 791. The vertical scanning control circuit 811 is electrically connected to the vertical scanning mirror 812. The horizontal scanning control circuit 791 is electrically connected to the horizontal scanning mirror 792. The image signal processing portion 70 is electrically connected to the vertical scanning mirror 812 through the vertical scanning control circuit 811. The image signal processing portion 70 is electrically connected to the horizontal scanning mirror 792 through the horizontal scanning control circuit 791. The configuration that is described above makes it possible for the display portion 40 to reflect the laser beams in the desired direction.

The input portion 41 performs input of various types of operations and setting information to the HMD 200. The input portion 41 is provided with an operation button group 50 and an input control circuit 51. The operation button group 50 is provided with various types of function keys and the like. The input control circuit 51 detects that a key in the operation button group 50 has been operated and notifies the control portion 46. The operation button group 50 is electrically connected to the input control circuit 51. The input control circuit 51 is electrically connected to the control portion 46. The control portion 46 recognizes information that is input to the keys of the operation button group 50.

The communication portion 43 receives the audio text from an external device (a PC or the like) as necessary. The communication portion 43 is provided with a communication module 57 and a communication control circuit 58. The communication module 57 uses radio waves to receive the audio text from the external device. The communication control circuit 58 controls the communication module 57. The control portion 46 is electrically connected to the communication control circuit 58. The communication module 57 is electrically connected to the communication control circuit 58. The control portion 46 receives the audio text through the communication portion 43. Note that the communication method that is used by the communication module 57 is not specifically limited, and any known wireless communication method can be used. For example, any wireless communication method that complies with Bluetooth (registered trademark), ultra-wide band (UWB) standards, wireless LAN standards (IEEE 802.11b, 11g, 11n, or the like), wireless USB standards, or the like can be used. A wireless communication method that uses infrared light and complies with the Infrared Data Association (IrDA) standards can also be used.

The control portion 46 is electrically connected to the camera 7 and acquires the captured image that is captured by the camera 7. The control portion 46 is also electrically connected to the microphone 8 and acquires the sound that is collected by the microphone 8.

The power supply portion 47 is provided with a battery 59 and a charging control circuit 60. The battery 59 serves as the power supply that drives the HMD 200. The battery 59 is a chargeable secondary battery. The charging control circuit 60 supplies the electric power of the battery 59 to the HMD 200. The charging control circuit 60 charges the battery 59 by supplying to the battery 59 electric power that is supplied from a charging adapter (not shown in the drawings).

Various types of setting information for the HMD 200, the captured image that is captured using the camera 7, the audio text, and the like are stored in the flash memory 49. The flash memory 49 is electrically connected to the control portion 46. The control portion 46 is able to refer to the information that is stored in the flash memory 49.

The control portion 46 controls the entire HMD 200. For example, the control portion 46 causes the desired image to be displayed on the display portion 40. The control portion 46 is at least provided with a CPU 61, a ROM 62, and a RAM 48. The ROM 62 stores various types of programs. The RAM 48 stores various types of data temporarily. In the control portion 46, the CPU 61 performs various types of processing by reading the various types of programs that are stored in the ROM 62. The RAM 48 is provided with storage areas for various types of flags (a first flag to a third flag), timers, and the like that are required when the CPU 61 performs the various types of processing. The first flag indicates whether the collecting of the speech sound has been started. The second flag indicates whether the creating of the audio text has been completed. The third flag indicates whether the creating of the display image has been completed (details will be described later).

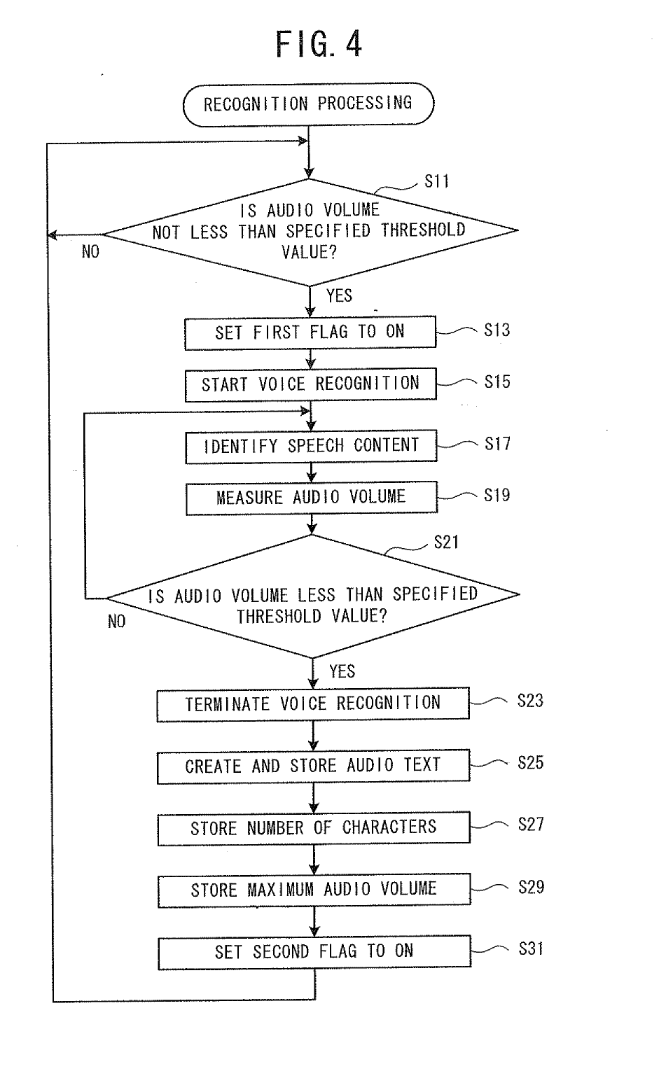

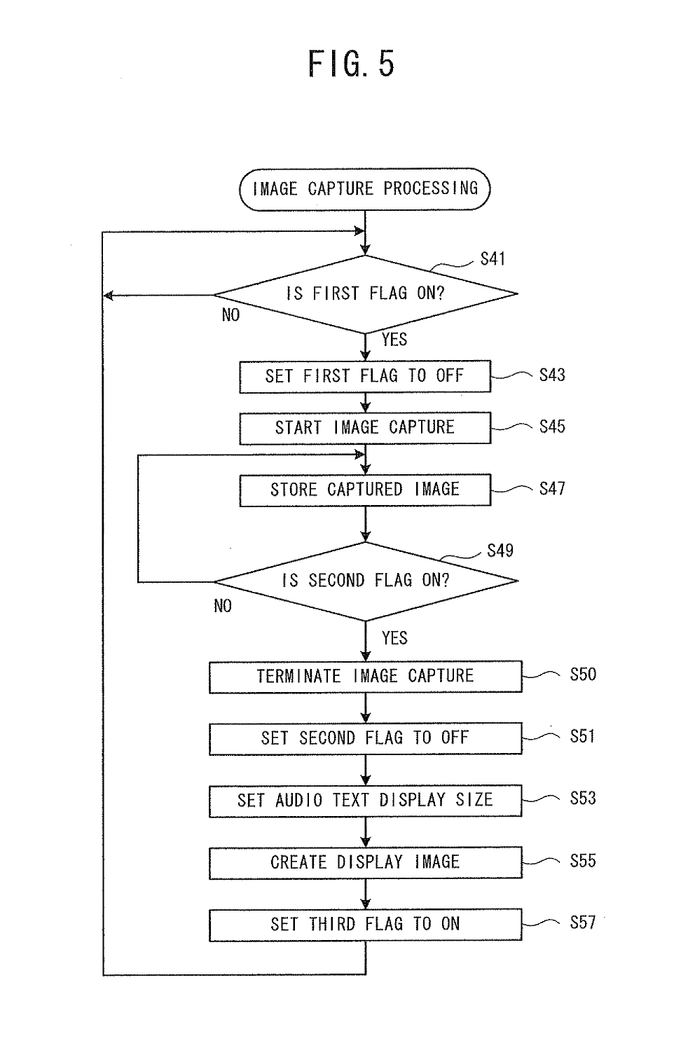

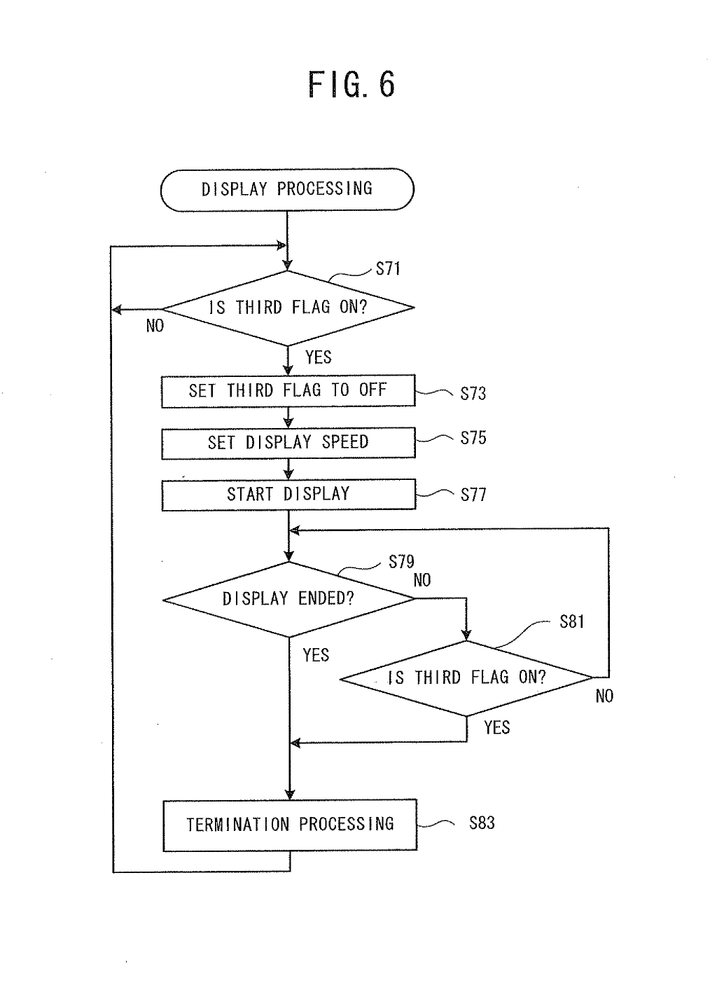

The various types of processing (recognition processing, image capture processing, display processing) that are performed by the CPU 61 of the HMD 200 will be explained with reference to FIGS. 4 to 6. In the recognition processing (refer to FIG. 4), the voice recognition is performed based on the sound that has been collected using the microphone 8, and the audio text is created. In the image capture processing (refer to FIG. 5), the captured image is captured using the camera 7, and the display image is created. In the display processing (refer to FIG. 6), the created display image is displayed. Each of the types of processing is started and performed by the CPU 61 after the HMD 200 power supply is turned on. The various types of processing are also performed sequentially on a cycle that is specified by the OS (a time slice system). The recognition processing, the image capture processing, and the display processing are therefore performed in parallel. Note that the CPU 61 switches among the various types of processing by what is called an event-driven method. Note that the first flag to the third flag that are stored in the RAM 48 are initialized by being set to OFF when the HMD 200 is started.

The recognition processing will be explained with reference to FIG. 4. When the recognition processing is started, a determination is made as to whether the audio volume of the speech sound of the explainer 6 that has been collected by the microphone 8 is not less than a specified threshold value (Step S11). In a case where the audio volume is less than the specified threshold value (NO at Step S11), a determination is made that the audio volume is low and the explainer 6 has not started to speak, so the processing returns to Step S11, and the audio volume of the speech sound continues to be monitored. In a case where the audio volume is not less than the specified threshold value (YES at Step S11), a determination is made that the explainer 6 has started to speak, so the collecting of the speech sound is started. At this time, the first flag in the RAM 48 is set to ON to indicate that the collecting of the speech sound has been started (Step S13).

The voice recognition of the speech sound that has been collected using the microphone 8 is started (Step S15). The result of voice recognition is that the speech content is identified (Step S17). The audio volume of the collected speech sound is measured (Step S19), and a determination is made as to whether the measured audio volume is less than a specified threshold value (Step S21). In a case where the measured audio volume is continuously not less than a specified threshold value (NO at Step S21), the processing returns to Step S17, and the identifying of the speech content continues to be performed. Because the speech content is thus identified by the voice recognition, the display image can be created by processing that will be described later, even in a case where the audio text has not been prepared in advance.

In a case where the audio volume that is measured by the processing at Step S19 is less than a specified threshold value (YES at Step S21), a determination is made that the speech of the explainer 6 has ended, and the voice recognition processing that was started at Step S15 is terminated (Step S23). Thus, in a case where the audio volume of the speech sound is not less than the specified threshold value, the speech sound is collected, and if the audio volume is less than the specified threshold value, the speech sound is not collected. Therefore, because the speech sound is reliably collected and the voice recognition is performed, the speech sound can be acquired without any of the sound being lost. The audio text is created from the speech content that was identified by the processing at Step S17, and the audio text is stored in the flash memory 49 (Step S25). The number of characters in the audio text is counted, and the number of characters is stored in the RAM 48 (Step S27). The greatest audio volume that was measured by the processing at Step S19 (hereinafter called the maximum audio volume) is stored in the RAM 48 (Step S29). The second flag in the RAM 48 is set to ON to indicate that the creating of the audio text has been completed (Step S31). The processing then returns to Step S11.

The image capture processing will be explained with reference to FIG. 5. When the image capture processing is started, a determination is made as to whether the first flag in the RAM 48 is set to ON (Step S41). In a case where the first flag is set to OFF (NO at Step S41), a state exists in which the explainer 6 has not begun speaking and the speech sound is not being collected, so the processing returns to Step S41, and the first flag continues to be monitored.

In a case where the first flag is set to ON (YES at Step S41), the explainer 6 has begun speaking, and the collecting of the speech sound and the voice recognition have been started (refer to FIG. 4, Steps S13 and S15). The first flag is set to OFF (Step S43). The image capture by the camera 7 is started (Step S45). The captured image that is acquired by the camera 7 is stored in the flash memory 49 (Step S47). As was explained previously, when the audio text for creating the display image is superimposed on the captured image, the starting time of the audio text display and the starting time of the captured image are matched by starting the image capture by the camera 7 in conjunction with the start of the speaking by the explainer 6.

A determination is made as to whether the second flag is set to ON (Step S49). In a case where the second flag is set to OFF (NO at Step S49), the speech sound of the explainer 6 is being collected, and the voice recognition is being performed continuously, so the processing returns to Step S47. The image capture by the camera 7 is continued, and the captured image is stored in the flash memory 49. In a case where the second flag is set to ON (YES at Step S49), it indicates that the explainer 6 has stopped speaking and that the creating of the audio text has been completed (refer to FIG. 4, Step S31). The image capture by the camera 7 is terminated (Step S50). As was explained previously, when the audio text for creating the display image is superimposed on the captured image, the ending time of the audio text display and the ending time of the captured image are matched by terminating the image capture by the camera 7 in conjunction with the end of the speaking by the explainer 6. The second flag is set to OFF (Step S51). The maximum audio volume that was stored in the RAM 48 at Step S29 (refer to FIG. 4) is read, and the size of the audio text that is superimposed on the captured image when the display image is created is set based on the maximum audio volume (Step S53). For example, the size of the audio text that is superimposed on the captured image may be set such that the audio text becomes larger as the maximum audio volume becomes greater. This makes it possible for the user to recognize the audio volume of the displayed audio text.

The audio text is superimposed on the captured image by matching the starting time of the captured image and the starting time of the audio text display. This processing creates the display image such that the captured image and the audio text display are synchronized (Step S55). The audio text is superimposed on the captured image at the size that was set by the processing at Step S53. When the creating of the display image has been completed, the third flag in the RAM 48 is set to ON in order to indicate that the creating of the display image has been completed (Step S57). The processing returns to Step S41.

The display processing will be explained with reference to FIG. 6. When the display processing is started, a determination is made as to whether the third flag in the RAM 48 is set to ON (Step S71). In a case where the third flag in the RAM 48 is set to OFF (NO at Step S71), the creating of the display image has not been completed, so the processing returns to Step S71, and the third flag continues to be monitored.

In a case where the third flag in the RAM 48 is set to ON (YES at Step S71), it indicates that the creating of the display image has been completed (refer to FIG. 5, Step S57). The third flag is set to OFF (Step S73). The number of characters in the audio text, which was stored in the RAM 46 by the processing at Step S27 (refer to FIG. 4), is read, and the display speed at which the display image is displayed is set based on the number of characters (Step S75). For example, the display speed for the display image may be set such that the display speed increases as the number of characters becomes greater. This makes the display time for the display image as short as it can be without hindering the recognition of the audio text by the user.

Note that in the present embodiment, the display speed at which the display image is displayed is set based on the number of characters. However, the present disclosure is not limited to this method. For example, the display speed may also be set based on the data volume, the number of words, or the like of the audio text.

The processing that displays the display image is started based on the display speed that has been set at Step S75 (Step S77). The user of the HMD 200 is able to visually recognize the display image. In the display image, the captured image and the audio text display are synchronized (the starting times and the ending times of the captured image and the audio text display are aligned), so the user is able to recognize that the captured image and the audio text are associated with one another.

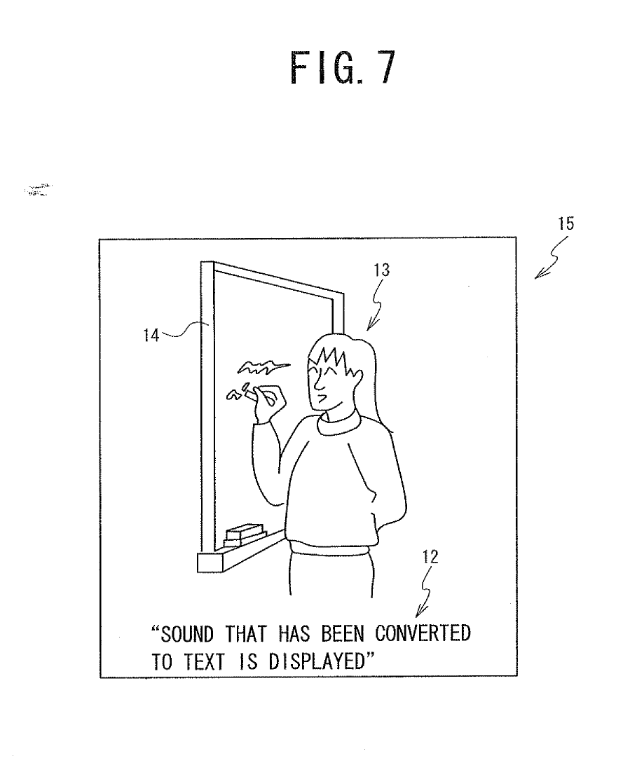

A display image 15 that is an example of the display image will be explained with reference to FIG. 7. An image 13 of the explainer and an image 14 of the whiteboard are included in the display image 15. The explainer is explaining something while pointing to the whiteboard. An audio text 12 that has been created by converting the speech sound of the explainer to text is displayed in the display image 15. The user of the HMD 200 is able to understand what the explainer is saying by visually recognizing the speech sound of the explainer in the form of the audio text 12. The display timing for the audio text 12 is synchronized to the timing at which the explainer is speaking. This makes it possible for the user of the HMD 200 to recognize that the content of the audio text 12 is associated with the timing at which the explainer points to the whiteboard, so the user is able to adequately understand the explainer's explanation.

As shown in FIG. 6, a determination is made as to whether the created display image has been displayed to the end (Step S79). In a case where the display image has been displayed to the end (YES at Step S79), termination processing to terminate the display (initialization of the display portion 40 and the like) is performed (Step S83), and the processing returns to Step S71. On the other hand, in a case where a portion of the display image remains to be displayed (NO at Step S79), determination is made as to whether the third flag is set to ON (Step S81). The third flag is set to ON (refer to FIG. 5, Step S57) in a case where, in the recognition processing (refer to FIG. 4), a sound has been newly detected whose audio volume is not less than the specified threshold value, and the audio text (a new audio text) for the newly detected sound has been created (refer to FIG. 4, Step S25), and where, in the image capture processing (refer to FIG. 5), the captured image (a new captured image) has been newly acquired (refer to FIG. 5, Step S47), and the creating of the display image (a new display image) has been completed (refer to FIG. 5, Step S55). In a case where the third flag is set to ON (YES at Step S81), it indicates that the creating of the new display image has been completed, so it is necessary to switch the display image that is being displayed to the new display image. The processing advances to Step S83 in order to terminate the display of the display image that is currently being displayed. Once the display of the display image has been terminated (Step S83), the processing returns to Step S71. At this point, the third flag is set to ON (YES at Step S71), so after the third flag has been set to OFF (Step S73) and the display speed has been set (Step S75), the display of the new display image that was created in the image capture processing (refer to FIG. 5) is started (Step S77). The processing the has been described above makes it possible to display the new display image without delay, so it is possible to prevent display delays from accumulating. The user is able to recognize the display image without delay.

On the other hand, in a case where the third flag is set to OFF (NO at Step S81), the new display image has not been created, so the processing returns to Step S79 in order to continue displaying the display image that is currently being displayed.

As was explained previously, in the HMD 200, the display image is created by taking the audio text that is created by the voice recognition and superimposing it on the captured image that is captured using the camera 7. Because the captured image is stored in the flash memory 49, the display image in which the captured image and the audio text are synchronized can be created even in a case where the creating of the audio text takes some time. Furthermore, the displaying of the captured image and the audio text in the display image can easily be synchronized by matching the starting times and the ending times of the captured image and the audio text. This makes it possible for the user to recognize that the captured image and the audio text are associated with one another.

Note that the present disclosure is not limited to the embodiment that is described above, and various types of modifications are possible. In the embodiment that is described above, the content of the explainer's speech is identified by performing the voice recognition on the speech sound of the explainer that was collected using the microphone 8 of the HMD 200, and the audio text is created based on the speech content. However, the present disclosure is not limited to this method. For example, the audio text may also be created by having an operator or the like input the speech content as text to an external device (a PC or the like). The HMD 200 may then receive the audio text from the external device (the PC or the like) through the communication portion 43 and may create the display image by superimposing the received audio text on the captured image. Hereinafter, a modified example of the present disclosure will be explained.

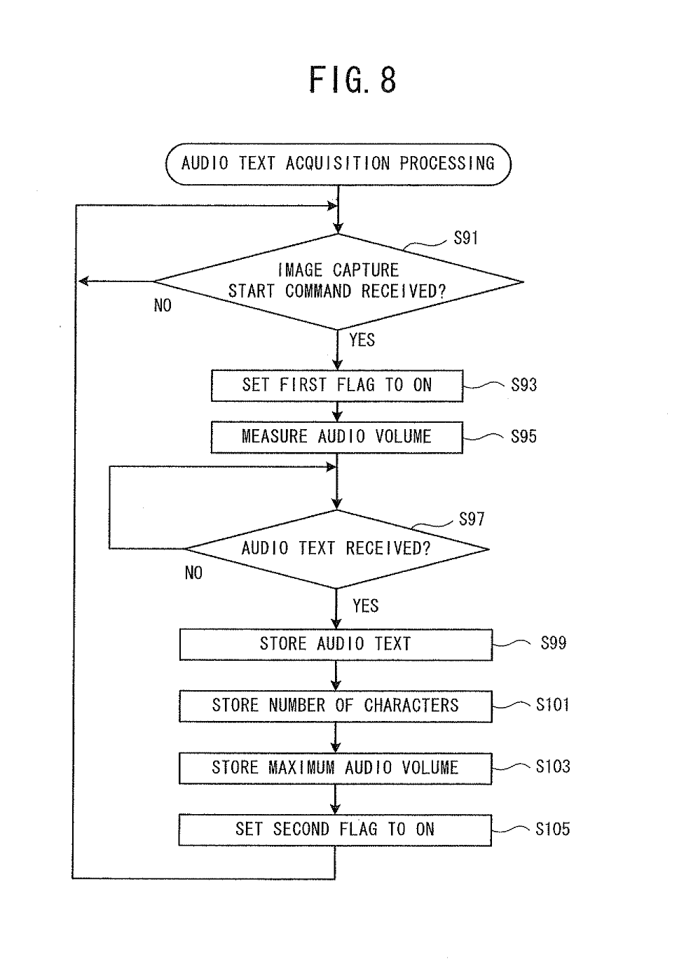

Audio text acquisition processing in the modified example of the present disclosure will be explained with reference to FIG. 8. In the audio text acquisition processing, processing is performed that receives the audio text from an external device. The audio text acquisition processing is started and performed by the CPU 61 when the power supply to the HMD 200 is turned on. The audio text acquisition processing is performed instead of the recognition processing that is performed in the embodiment that is described above. The image capture processing and the display processing are the same as in the embodiment that is described above, so explanations of those will be omitted.

As shown in FIG. 8, when the audio text acquisition processing is started, a determination is made as to whether a command has been received from the external device through the communication portion 43 to start the image capture of the explainer by the camera 7 (Step S91). In a case where the command has not been received through the communication portion 43 (NO at Step S91), the processing returns to Step S91, and the receiving of the start command continues to be monitored.

When the input of the text to the external device is started by the operator or the like, that is, when the creating of the audio text is started, the external device transmits to the HMD 200 the command to start the image capture by the camera 7. When the HMD 200 receives from the external device the command to start the image capture by the camera 7 (YES at Step S91), the HMD 200 sets the first flag in the RAM 48 to ON in order to start the image capture by the camera 7 (Step S93). The audio volume of the speech sound of the explainer that is collected using the microphone 8 is measured (Step S95). Note that in the image capture processing (refer to FIG. 5), in a case where the first flag is set to ON (refer to FIG. 5, YES at Step S41), the image capture by the camera 7 is started (refer to FIG. 5, Step S45). The captured image that is captured is stored in the flash memory 49 (refer to FIG. 5, Step S47).

Next, a determination is made as to whether the audio text has been received from the external device through the communication portion 43 (Step S97). In a case where the audio text has not been received from the external device (NO at Step S97), the processing returns to Step S97, and the receiving of the audio text continues to be monitored.

When the text input of the speech content of the explainer has been completed by the operator, the external device transmits to the HMD 200 the audio text that has been created by the text input. When the audio text is transmitted from the external device, the HMD 200 receives the audio text through the communication portion 43 (YES at Step S97).

In a case where the HMD 200 has received the audio text that was transmitted from the external device, the received audio text is stored in the flash memory 49 (Step S99). The number of characters in the audio text is counted, and the number of characters is stored in the RAM 48 (Step S101). The maximum audio volume of the speech sound that was measured by the processing at Step S95 is stored in the RAM 48 (Step S103). The second flag in the RAM 48 is set to ON to indicate that the creating of the audio text has been completed (Step S105), and the processing returns to Step S91.

As explained above, in the modified example, the audio text is received from the external device, and the display image is created based on the audio text and the captured image. In the modified example, the processing in the HMD 200 that creates the audio text by the voice recognition is not necessary, so the processing load on the HMD 200 can be reduced. Furthermore, in the modified example, the image capture starts at the point when the HMD 200 receives the command to start the image capture from the external device. Because the external device can thus control the timing at which the image capture by the camera 7 of the HMD 200 starts, the external device can match the starting time of the audio text that is created in the external device and the starting time of the captured image that is captured by the camera 7 of the HMD 200. Therefore, the audio text and the captured image can be easily synchronized.

Note that the present disclosure is not limited to the embodiment that is described above, and various types of modifications are possible. In the embodiment that is described above, the display image is created such that the starting time and the ending time of the captured image are respectively matched to the starting time and the ending time of the display of the audio text. However, the present disclosure is not limited to this method. For example, time stamps that indicate the starting times and the ending times of the audio text and the captured image may also be stored. The display image may then be created by matching the time stamps in order to superimpose the audio text on the captured image.

In the embodiment that is described above, the display image is created by superimposing the audio text on the captured image that has been captured by the camera 7 of the HMD 200, but the present disclosure is not limited to this method. The HMD 200 may also receive, through the communication portion 43, a captured image that has been captured by a different camera, and the display image may be created by superimposing the created audio text on the captured image that has been received.

In the embodiment that is described above, the size of the characters in the audio text is changed in accordance with the audio volume of the collected sound, but the present disclosure is not limited to this method. For example, the color of the audio text may also be changed in accordance with the audio volume of the collected sound. To take another example, an indicator that indicates the audio volume of the sound may also be created separately and displayed.

In the embodiment that is described above, the voice recognition processing is started when the audio volume of the collected sound reaches the specified threshold value, and the voice recognition processing is terminated when the audio volume falls below the specified threshold value. However, the present disclosure is not limited to this method. For example, the voice recognition processing may also be started when a state in which the audio volume is not less than the specified threshold value continues for at least a specified length of time. The voice recognition processing may also be terminated when a state in which the audio volume is less than the specified threshold value continues for at least a specified length of time.

What is claimed is:

1. A head-mounted display, comprising:
an image capture device that captures an image;
a first setting device that sets a starting time for the capturing of the image by the image capture device;
a start command device that causes the image capture device to start capturing the image at the starting time that has been set by the first setting device;
a first acquiring device that, after the starting time that has been set by the first setting device, acquires an audio text in which sound that is emitted by an object captured by the image capture device has been converted into text;
a storage control device that stores in a storage device the image that has been captured during an interval from the time that the capturing of the image is started by the start command device until the audio text is acquired by the first acquiring device;
a first creating device that, after the audio text has been acquired by the first acquiring device, creates a display image in which the captured image and the audio text are synchronized by superimposing the audio text on the captured image such that the starting time of the captured image that is stored in the storage device and the starting time of a display of the audio text are matched to one another; and
a display control device that outputs the display image that has been created by the first creating device.

2. The head-mounted display according to claim 1, wherein
the first setting device, in a state in which the display image has been output by the display control device, sets a new starting time that is a new setting of the starting time,
the first acquiring device, in a state in which the display image has been output by the display control device, acquires a new audio text that is a new version of the audio text,
the storage control device stores in the storage device a new captured image that is an image that has been captured during an interval from the time that the new starting time is set by the first setting device until the new audio text is acquired by the first acquiring device,
the first creating device creates a new display image that is a display image in which the new audio text is superimposed on the new captured image that is stored in the storage device, and
the display control device, in a case where the new display image has been created while the display image is being output, halts the output of the display image that is being output and outputs the new display image.

3. The head-mounted display according to claim 1, wherein
the display control device changes a display speed of the display image in accordance with the amount of the audio text that has been acquired by the first acquiring device.

4. The head-mounted display according to claim 3, wherein
the display control device uses the number of characters in the audio text as the amount of the audio text.

5. The head-mounted display according to claim 1, further comprising:
a second acquiring device that measures an audio volume of the sound that is converted into the audio text,
wherein
the first creating device changes the display size of the audio text in accordance with the audio volume that has been acquired by the second acquiring device and creates the display image by superimposing on the captured image the audio text whose display size has been changed.

6. The head-mounted display according to claim 1, further comprising:
a sound collecting device that collects sound; and
a second creating device that creates the audio text by recognizing the sound that has been collected by the sound collecting device,
wherein
the first acquiring device, after the audio text has been created by the second creating device, acquires the audio text that has been created.

7. The head-mounted display according to claim 6, wherein
the first setting device sets, as the starting time, a time at which the audio volume of the sound that is collected by the sound collecting device changes from less than a specified threshold value to not less than the threshold value.

8. The head-mounted display according to claim 6, further comprising:
a second setting device that sets, as an ending time, a time at which the audio volume of the sound that is collected by the sound collecting device changes from not less than the specified threshold value to less than the threshold value,
wherein
the second creating device creates the audio text by recognizing the sound that that has been collected by the sound collecting device during an interval from the starting time to the ending time that has been set by the second setting device.

9. The head-mounted display according to claim 1, wherein
the first acquiring device includes a first receiving device that acquires the audio text by receiving the audio text from an external device.

10. The head-mounted display according to claim 9, further comprising:
a second receiving device that receives from an external device a command signal that indicates a specific time,
wherein
the first setting device sets, as the starting time, a time at which the command signal is received by the second receiving device.

11. A head-mounted display, comprising:
an image capture device that captures an image; and
a processor that is configured to execute instructions that are grouped into functional units, the instructions including
a first setting unit that sets a starting time for the capturing of the image by the image capture device,
a start command unit that causes the image capture device to start capturing the image at the starting time that has been set by the first setting unit,
a first acquiring unit that, after the starting time that has been set by the first setting unit, acquires an audio text in which sound that is emitted by an object captured by the image capture device has been converted into text,
a storage control unit that stores in a storage device the image that has been captured during an interval from the time that the capturing of the image is started by the start command unit until the audio text is acquired by the first acquiring unit,
a first creating unit that, after the audio text has been acquired by the first acquiring unit, creates a display image in which the captured image and the audio text are synchronized by superimposing the audio text on the captured image such that the starting time of the captured image that is stored in the storage device and the starting time of a display of the audio text are matched to one another, and
a display control unit that outputs the display image that has been created by the first creating unit.

12. A computer program product stored on a non-transitory computer-readable medium, comprising instructions for causing a processor of a head-mounted display to execute the steps of:
a first setting step that sets a starting time for capturing of an image;
a start command step that causes the capturing of the image to start at the starting time that has been set in the first setting step;
a first acquiring step that, after the starting time that has been set in the first setting step, acquires an audio text in which sound that is emitted by a captured object has been converted into text;
a storage control step that stores the image that has been captured during an interval from the time that the capturing of the image is started in the start command, step until the audio text is acquired in the first acquiring step;
a first creating step that, after the audio text has been acquired in the first acquiring step, creates a display image in which the captured image and the audio text are synchronized by superimposing the audio text on the captured image such that the starting time of the stored captured image and the starting time of a display of the audio text are matched to one another; and
a display control step that outputs the display image that has been created in the first creating step.
